(19) United States
(12) Patent Application Publication
(10) Pub. No.: US 2007/0112718 A1
(43) Pub. Date: May 17, 2007

(54) METHOD AND APPARATUS TO ENABLE INTEGRATED COMPUTATION OF MODEL-LEVEL AND DOMAIN-LEVEL BUSINESS SEMANTICS

(76) Inventors: Shixia Liu, Beijing (CN); Ying Liu, Beijing (CN); Zhao Ming Qiu, Beijing (CN); Guo Tong Xie, Xi Er Qi (CN); Jian Wang, Beijing (CN); Jun Zhu, Beijing (CN)

Correspondence Address: Ido Tuchman, 82-70 Beverly Road, Kew Gardens, NY, 11415, US

(21) Appl. No.: 11/552,623

(22) Filed: Oct. 25, 2006

(30) Foreign Application Priority Data
Oct. 25, 2005 (CN) 200510109557.X

(51) Int. Cl. G06N 5/02

(52) U.S. Cl. 706/47

(57) ABSTRACT

A method is provided for integrating model and domain semantics in business models. The method includes a business model inputting step for inputting the business model to be realized; a domain semantics locating step for locating the domain semantics of the modeling element of the business model within the domain ontology and outputting the corresponding domain model semantics; a model semantics transforming step for transforming the modeling element of the business model into business model semantics that are represented by a model ontology; and a unified semantic model forming step for combining the aforesaid business model semantics and domain model semantics and then outputting a unified semantic model. The teachings disclosed are directed to facilitate the integration and utilization of the semantics embedded in business models.

### CROSS-REFERENCE TO RELATED APPLICATIONS

This application claims priority under 35 U.S.C. § 119 to Chinese Application No. 200510109557.X filed Oct. 25, 2005, the entire text of which is specifically incorporated by reference herein.

### BACKGROUND OF THE INVENTION

With the widely adoption of model-driven approach in today's enterprises, business is being modeled as large amount of models residing in multi-layers (like strategy, operation, execution, implementation and etc.). But the semantics (meaning) within these models are still not well integrated and thus makes these models hard to understand, communicate, reuse and utilize.

Business semantics in models can be roughly divided into two categories:

1. Model-level semantics (hereinafter referred to as model semantics)

This level of semantics is usually embedded in the model meta-structure. Using business process model as a sample, each modeling element (e.g., activity, data object, control and etc.) and the relationship among multiple modeling elements (e.g., one activity will send/receive a data object) stands for a specific and clear meaning.

2. Domain-level semantics (hereinafter referred to as domain semantics)

This level of semantics is usually represented as domain knowledge and referenced in the word/phrases used by the business models. Each word used in the title, caption, or comment for the modeling elements/relationship stands for some specific and exact meaning in the domain semantics.

Currently, we have the following challenges in well manipulating and leveraging business semantics.

Firstly, different business modeling methods have different meta-model as a specification of the model semantics, and only these models that share the same meta-model can share a common base of semantics.

Secondly, there is no well-established standard to regulate and interpret the meaning embedded in the words and phrases within business models.

And more importantly, the model semantics and domain semantics, albeit important to business, are usually isolated when are actually divided into two isolated parts.

Some existing methods and approaches have been proposed and applied by different companies and organizations, implicitly or explicitly, to address the problem as identified above.

Unified Modeling Language (UML) is designed by OMG (Object Management Group) to specify, visualize and document models for software systems. With an objective to be a common modeling language for different kind of software elements, UML can be regarded as an effort to unify the model semantics. Meta Object Framework (MOF) is the specification in UML to support meta-model specification. All the models that conform to the same meta-model will share a common base of model-level semantics and thus be inter-operable. Yet the problem for UML lies in 1) it is still very hard to enforce all the modeling method to use a common language (like MOF) as its meta-model description language; 2) two models following different meta-model (even both are MOF based) still cannot share model-level semantics completely, it is still hard to establish relationship among these models.

Ontology is regarded by many as the best way to address the problem related to domain semantics. RDF(S) and DAML/OWL are defined by standard organizations to formally represent the concept and their relationships within a specific domain (such as Banking and Telecom). The major challenge, however, lies in the difficulty to have a common ontology acceptable to all related parties.

Both approaches described above, actually, don't take enough consideration for the business semantics isolation problem. That is, with today's approaches, models are either looked as a set of meta-structure without domain content (which needs to be understood by human being), or just a concept/relationship hierarchy without connection with the environment to which it applied. Yet when we need to have further understanding and utilizing of the models, through computer aided mechanisms, both levels of semantics are not just important, but actually indispensable. This problem has become a major obstacle for the further application of model-driven approach in well attacking business problems.

As a summary, today's problems in utilizing business semantics can be summarized as:

1. The model semantics and domain semantics are usually isolated in real business practices, making their integrated computation impossible.

2. The domain semantics within business models are ambiguous and there lacks a mechanism to share domain semantics among business models that follow different meta models.

### BRIEF SUMMARY OF THE INVENTION

An aspect of the present invention provides a method and apparatus to integrate model and domain semantics in business models, which can overcome the aforementioned drawbacks of the prior art. To this end, an exemplary method for integrating model and domain semantics in business models is provided. The method includes a business model inputting step for inputting the business model to be realized; a domain semantic locating step for locating the domain semantics of the modeling element of the business model within the domain ontology and output the corresponding domain model semantics; a model semantics transforming step for transforming the modeling element of the business model into business model semantics that are represented by model ontology; and a unified semantic model forming step for combining the aforesaid business model semantics and domain model semantics and then outputting the formed unified semantic model.

Another exemplary aspect of the invention is an apparatus for integrating model-level and domain-level semantics in business models. The apparatus includes a domain semantics locator configured to locate the domain semantics of the modeling element of the input business model within the domain ontology and output the corresponding domain model semantics; a model semantics transformer configured to transform the input modeling element of the business model into business model semantics that is represented by model ontology; and a unified semantic model builder configured to combine the aforesaid business model semantics and domain model semantics and then output the formed unified semantic model.

One point addressed is how to associate and combine the two kinds of semantics (domain-level and model-level) embedded in business models, given the fact that they may be created by different people following different meta-model and domain notations. Furthermore, a unique approach of using USM as a common base for both the model and domain semantics embedded in models is presented. In contrast to the common usage of ontology to represent concepts within a particular domain, the invention creatively uses it to represent the model semantics for a particular modeling method. The Unified Semantic Model (USM) uses concept and relationship as fundamental modeling elements and is organized in the form of Ontology. During the integration of model semantics and domain semantics, business models will be transformed into the representation of USM, then domain semantics within business models will be specified and located to the corresponding concepts/relationships in domain ontology, by annotating the words/phases that are used in the caption or comments of modeling elements. After that, the semantics within business models, no matter as model or domain, will be transformed into a unified semantic model, which can then be used to support further work like analysis, inference and so on.

To guarantee the quality of the generated USM, an inference engine will be used to validate the USM based on some constraints embedded in the domain and model ontology, and user-provided rules or policies.

The steps of the method provided by the invention herein can be automated by algorithms in software or assisted by tooling with graphical user interfaces.

The following advantages may be achieved:

Firstly, both domain and model semantics are captured and utilized, making full usage of existing models will create more meaningful business result and value.

Secondly, all the models in known modeling method and format are supported, without the need to enforce any strong preconditions for the modelers.

Finally, the integration of business semantics into Unified Semantic Model makes it possible to have multiple further usages, the business value is tremendous.

### BRIEF DESCRIPTION OF THE SEVERAL VIEWS OF THE DRAWINGS

These and other features, aspects and advantages of the present invention will more fully understood when considered with respect to the following detailed description, the contents of the accompanying drawings where:

FIG. 1 illustrates a schematic block diagram showing the specification and localization, according to the present invention, of the model and domain semantics of business models into model ontology and domain ontology;

FIG. 2 illustrates a schematic block diagram showing the apparatus' system architecture according to the present invention for integrating model and domain semantics in business models;

FIG. 3 illustrates a flowchart of the method according to the present invention for integrating model and domain semantics in business models;

FIG. 4 illustrates the metamodel for business process in UML;

FIG. 5 illustrates a sample domain ontology for banking;

FIG. 6 illustrates a sample credit loan business process;

FIG. 7 illustrates the normalization of the credit loan business process as shown in FIG. 6.

FIG. 8 illustrates the specific process flow of the model semantics transformation and domain semantics localization of business model.

### DETAILED DESCRIPTION OF THE INVENTION

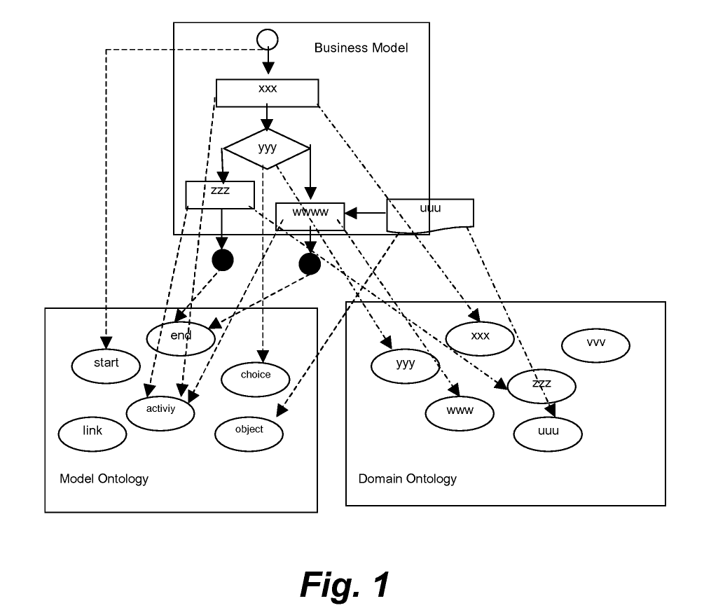

FIG. 1 schematically illustrates the specification and the localization of the model semantics and the domain semantics to model ontology and domain ontology, respectively, according to the method of the present invention for integrating model semantics and domain semantics in business model. More particularly, the model ontology captures model semantics and the domain ontology captures domain semantics, respectively. And then, by linking the modeling element of the business model to model ontology, and annotating words and phrases within modeling elements, such as caption or comments, as concepts/relationships in domain ontology, the semantics of a business model can be explicitly specified. The common ontology representation guarantees that both model-level and domain-level semantics can be transformed into Unified Semantic Model.

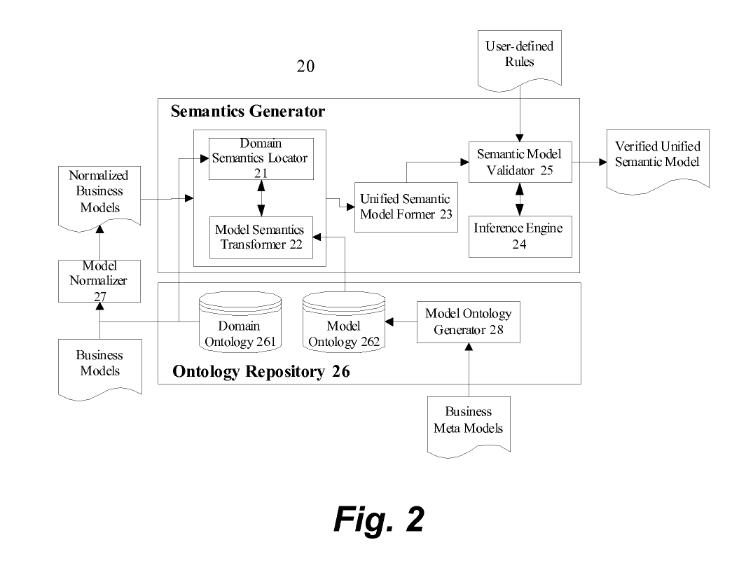

FIG. 2 shows the system architecture of the apparatus 20 according to the present invention for integrating model semantics and domain semantics in business model. The apparatus 20 has three major inputs: business models, i.e., Business Strategy/Operation and Solution Composition/Implementation level models; Meta models for business models, usually in terms of UML models; User-defined rules to describe constraints on the unified semantic model.

In addition, the output of the apparatus is Unified Semantic Model that has been verified by constraints embedded in model/domain ontology, and rules/policies provided by users.

The apparatus 20 shown in FIG. 2 comprises the following components: a domain semantics locator 21 used to locate domain concepts/relationships within model descriptions; a model semantics transformer 22 used to transform business models into ontology representation; unified semantic model builder 23 used to form unified semantic model from the business models processed by the domain semantics locator 21 and model semantics transformer 22. The apparatus 20 may optionally further comprises an inference engine 24, which may be either a general purpose rule engine or an enhanced description logic engine, and can infer new facts based on existing knowledge and deduce some conclusions from these facts. The apparatus 20 may further comprises a semantic model validator 25 used to validate unified semantic model based on user-defined rules and constraints embedded in domain/model ontology. The apparatus 20 also comprises an ontology repository 26 having domain ontology 261 and model ontology 262 that are used to store domain ontology and model ontology respectively.

Furthermore, the apparatus 20 may optionally comprises model normalizer 27 and model ontology generator 28 to support the processing procedure of the apparatus 20. The said model normalizer 27 can check and normalize vocabularies used in captions or comments within business model elements, based on vocabularies in domain ontology 261, and then the normalized business model is input into the said domain semantics locator 21 and model semantics transformer 22 for appropriate process. The model ontology generator 28 can generate model ontology representation based on metamodels in UML or XSD.

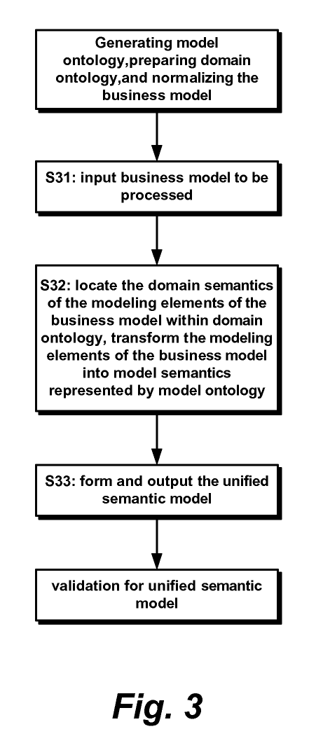

FIG. 3 illustrates a flowchart of the method according to the present invention for integrating model and domain semantics in business models.

A simple and complete example to realize the method of the present invention using the apparatus 20 thereof will be described below.

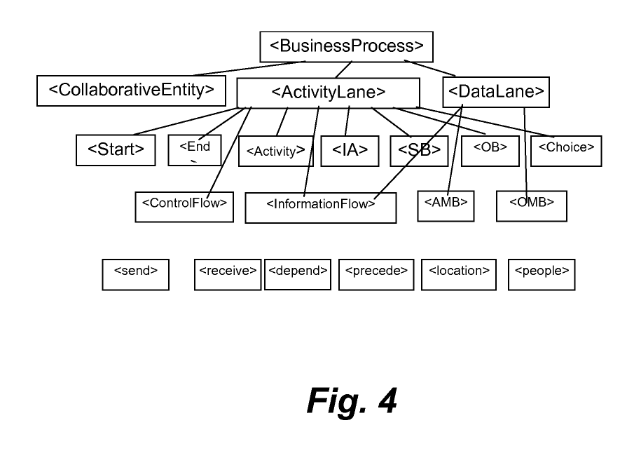

The apparatus 20 of the present invention may choose to generate model ontology 262 by the model ontology generator 28 based on metamodel prior the step S31 in FIG. 3. Let us use business process modeling as an example. FIG. 4 is a metamodel for business process in UML, which shows all the major modeling elements when modeling business processes, such as Activity, IA and DataLane etc.

Then the model ontology generator 28 generate model ontology 262 based on the metamodel for business process. A specific example of the model ontology 262 generated based on the metamodel in UML of FIG. 4 will be described below:

```
    ...
    //define the classes within model ontology
    <owl:Ontology
rdf:about=“http://semantics.crl.ibm.com/process”/>
    <owl:Class
    rdf:about=“http://semantics.crl.ibm.com/process#Activity”/>
    //corresponding to the <Activity> in FIG. 4
    <owl:Class
    rdf:about=“http://semantics.crl.ibm.com/process#ActivityLane”>
//corresponding to the < ActivityLane > in FIG. 4
    <owl:Class
rdf:about=“http://semantics.crl.ibm.com/process#BusinessProcess”/>
//corresponding to the < BusinessProcess > in FIG. 4
    <owl:Class
    rdf:about=“http://semantics.crl.ibm.com/process#Choice”/>
    //corresponding to the < Choice > in FIG. 4
    <owl:Class
    rdf:about=“http://semantics.crl.ibm.com/process#ControlFlow
”/>
    //corresponding to the < ControlFlow > in FIG. 4
    <owl:Class
    rdf:about=“http://semantics.crl.ibm.com/process#IA”/>
    //corresponding to the < IA > in FIG. 4
    <owl:Class
rdf:about=“http://semantics.crl.ibm.com/process#InformationFlow”/>
    //corresponding to the < InformationFlow > in FIG. 4
    ...//It should be noted that not all the classes within the
model ontology are shown here.
    //define relationship hasActivity
    <owl:ObjectProperty
rdf:about=“http://semantics.crl.ibm.com/process#hasActivity”>
    //the name of the relationship is hasActivity
    <rdfs:domain
    rdf:about=“http://semantics.crl.ibm.com/process#ActivityLane”/
>
    //the head of the relationship is ActivityLane
    <rdfs:range
    rdf:about=“http://semantics.crl.ibm.com/process#Activity”/>
    //the foot of the relationship is Activity
    </owl:ObjectProperty>
    //define the relationship hasActivityLane
    <owl:ObjectProperty
rdf:about=“http://semantics.crl.ibm.com/process#hasActivityLane”>
    //the name of the relationship is hasActivityLane
    <rdfs:domain
rdf:about=“http://semantics.crl.ibm.com/process#BusinessProcess”/>
    //the head of the relationship is BusinessProcess
    <rdfs:range
rdf:about=“http://semantics.crl.ibm.com/process#ActivityLane”/>
    //the foot of the relationship is ActivityLane
    </owl:ObjectProperty>
    ...
```

The generated model ontology 262 will be stored in the Ontology Repository 26.

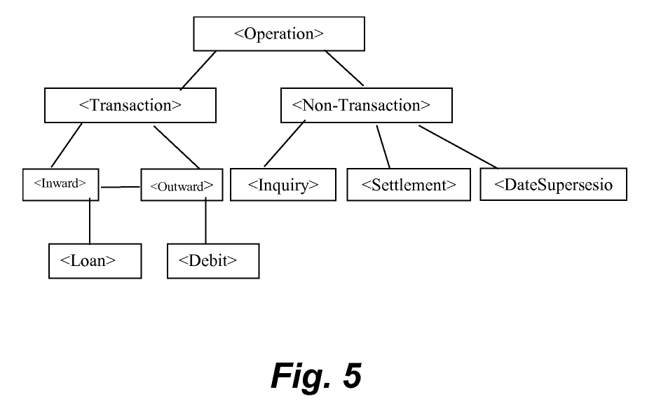

The apparatus 20 of the present invention also prepares domain ontology 261 prior step S31. The domain ontology 261 captures domain semantics that are used in business models. It comes from industry standards or domain experts, and can be reused. FIG. 5 is a sample domain ontology for banking.

The following example shows a domain ontology for banking.

```
    ...
    //define domain ontology banking
    <owl:Ontology
    rdf:about=“http://semantics.crl.ibm.com/banking”/>
    //define class Operation, corresponding to the <Operation>
in FIG. 5
    <owl:Class
    rdf:about=“http://semantics.crl.ibm.com/banking#Operation”/
>
    //define class Transaction, corresponding to the
<Transaction > in FIG. 5
    <owl:Class
    rdf:about=“http://semantics.crl.ibm.com/banking#Transaction
”>
    <rdfs:subClassOf
rdf:about=“http://semantics.crl.ibm.com/banking#Operation”/>
    Indicating to be sub-class of <operation>
    </owl:Class>
    //define class Non Transaction, corresponding to the <Non
Transaction>in FIG. 5
    <owl:Class
rdf:about=“http://semantics.crl.ibm.com/banking#NonTransaction”>
    <rdfs:subClassOf
rdf:about=“http://semantics.crl.ibm.com/banking#Operation”/>
    Indicating to be sub-class of <operation>
    <owl:disjointWith
rdf:about=“http://semantics.crl.ibm.com/banking#Transaction”/>
    Indicating there is no connection with Transaction
    </owl:Class>
    //define instance Inward, corresponding to the <Inward>in
    <owl:Class
    rdf:about=“http://semantics.crl.ibm.com/banking#Inward”>
    <rdfs:type
    rdf:about=“http://semantics.crl.ibm.com/banking#Transaction
”/>
    //indicating it belongs to class Transaction
    <owl:sameAs
    rdf:about=“http://semantics.crl.ibm.com/banking#Loan”/>
    //indicating it is the same as Loan
    </owl:Class>
    //define instance Outward, corresponding to <Outward>in
    <owl:Class
    rdf:about=“http://semantics.crl.ibm.com/banking#Outward”>
    <rdfs:type
    rdf:about=“http://semantics.crl.ibm.com/banking#Transaction
”/>
    //indicating it belongs to class Transaction
    <owl:differentFrom
rdf:about=“http://semantics.crl.ibm.com/banking#Inward”/>
    //indicating it is different from Inward
    <owl:sameAs
    rdf:about=“http://semantics.crl.ibm.com/banking#Debit”/>
    //indicating it is the same as Debit
    </owl:Class>
    //define Instance Inquiry, corresponding to <Inquiry> in
    <owl:Class
    rdf:about=“http://semantics.crl.ibm.com/banking#Inquiry”>
    <rdfs:type
rdf:about=“http://semantics.crl.ibm.com/banking#NonTransaction”/>
    //indicating it belongs to class Non Transaction
    </owl:Class>
    //define instance Settlement, corresponding to
<Settlement>in FIG. 5
    <owl:Class
    rdf:about=“http://semantics.crl.ibm.com/banking#Settlement”
>
    <rdfs:type
rdf:about=“http://semantics.crl.ibm.com/banking#NonTransaction”/>
    //indicating it belongs to class Non Transaction
    </owl:Class>
    ...
```

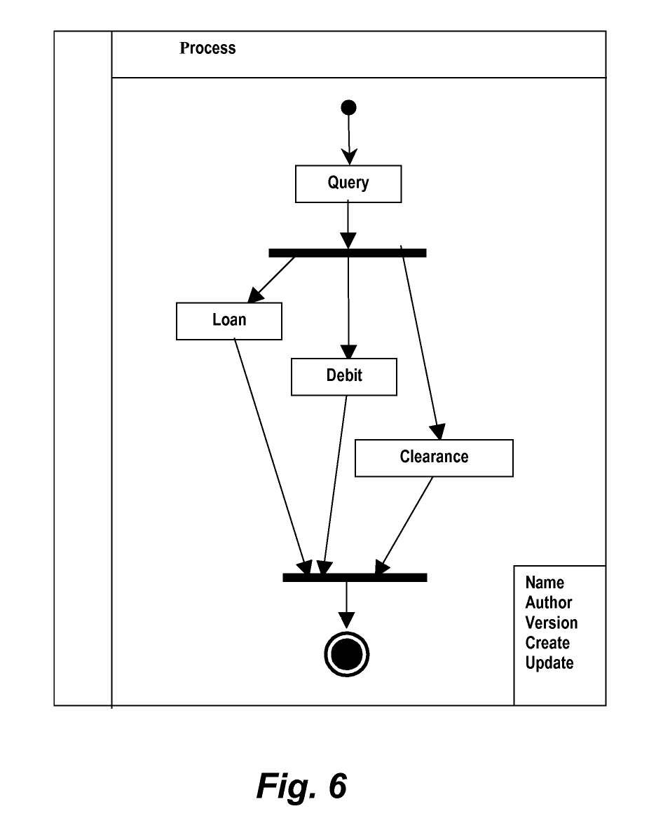

The apparatus 20 of the present invention may optionally normalize the business model to be processed prior step S31. FIG. 6 is an example of credit loan business process, wherein doing “query” activity first, and then doing “loan”, “debit” and “clearance” activities in parallel. The semantics of the process, although looks quite clear for human, is not so for machine because the semantics within the flow structure and the semantics for the specific usage domain (here Banking industry) are not so well integrated.

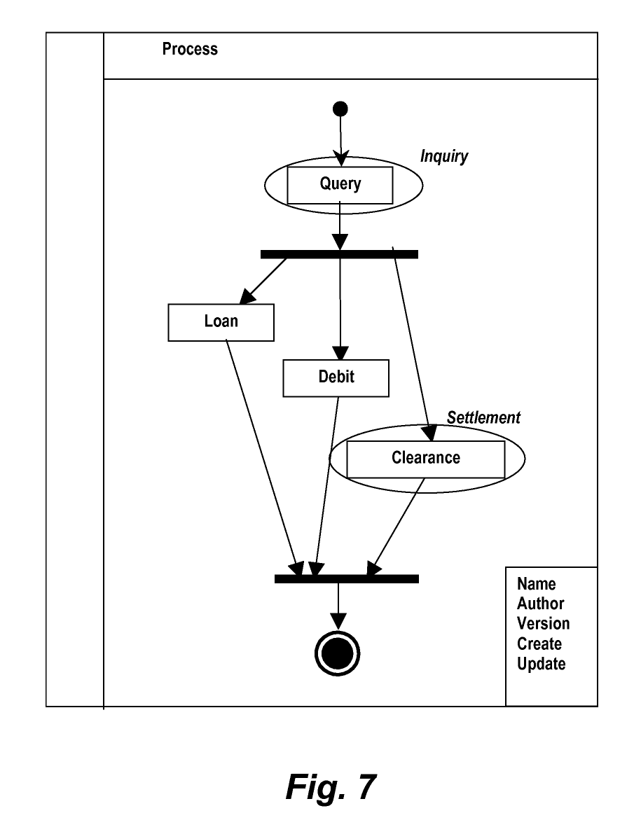

Based on text analysis technologies, vocabularies used in the business process will be analyzed and normalized based on vocabularies in domain ontology. Referring to FIG. 7, model normalizer 27 will generate, according to the existing normalization technologies and based on the domain ontology as shown in FIG. 5, a normalized business process, wherein ‘query’ has been normalized as ‘inquiry’, and ‘clearance’ has been normalized as ‘settlement’.

Referring back to FIG. 3, the business model to be processed is input in step S31 (may be processed with normalization).

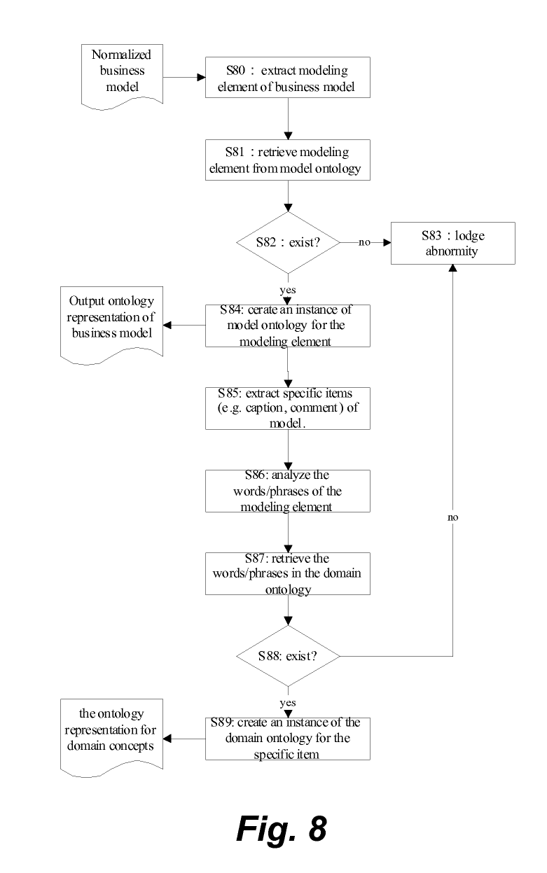

In step S32, normalized business model will be transformed into business model semantics represented by model ontology by model semantics transformer 22. The domain semantics locator 21 will traverse the generated business model semantics, and then look up and locate the domain concepts or relationships occurs in business model semantics within domain ontology 261. The domain semantics locator 21 and model semantics transformer 22 will take domain ontology, model ontology and normalized business model as inputs. The domain semantics locator 21 will locate words/phrases within captions/comments in the modeling elements of the business model to corresponding concepts/relationships in domain ontology 261. And the model semantics transformer 22 will transform business models into business model semantics. The specific process flow of step S32 is as shown in FIG. 8.

In FIG. 8, the model semantics transformer 22 extracts modeling element of business model from normalized business model in step S80. In step S81, the model semantics transformer 22 locates modeling element within the model ontology 262. And it is determined in step S82 whether said modeling element exists, and if it is determined that no modeling element exists, then the process proceeds and exception is thrown in step S83. If it is determined in step S82 that the said modeling element exists, then an instance of model ontology is created in step S84 for the modeling element, and the ontology representation of business model, i.e., business model semantics, will be output. In step S85, the specific items (e.g. caption, comment) are extracted. And in step S86, the words/phrases of the modeling element are analyzed. In step S87, the domain semantics locator 21 retrieves said words/phrases in the domain ontology 261. And it is determined in step S88 whether there exist the said words/phrases, and if it is determined that said words/phrases do not exist, then the process proceeds and abnormity is lodged in step S83. If it is determined in step S88 that there exists such words/phrases, then an instance of the domain ontology is created in step S89 for the specific item, and the ontology representation for domain concepts, i.e., domain model semantics, will be output.

In step S33 in FIG. 3, the business model semantics and domain model semantics generated by the aforesaid process are combined herein by unified semantic model builder 23, and the unified semantic model will be output.

Here is the sample unified semantic model that is generated for the business process shown in FIG. 7.

```
    //define process as CreditLoan
    <process:BusinessProcess
rdf:about=“http://semantics.crl.ibm.com/SinoPac#CreditLoan”/>
    //define activity A001
    <process:Activity
rdf:about=“http://semantics.crl.ibm.com/SinoPac#A001”>
    <process:activityLabel
rdf:about=“http://semantics.crl.ibm.com/banking#Inquiry”/>
    //indicating the activity A001 is Inquiry
    <process:precede
    rdf:about=“http://semantics.crl.ibm.com/SinoPac#A002”/>
    //indicating A001 is before A002
    </process:Activity>
    //define activity A002
    <process:Activity
    rdf:about=“http://semantics.crl.ibm.com/SinoPac#A002”>
    <process:activityLabel
rdf:about=“http://semantics.crl.ibm.com/banking#Loan”/>
    //indicating activity A002 is Loan
    <process:parallel
    rdf:about=“http://semantics.crl.ibm.com/SinoPac#A003”/>
    //indicating activity A002 and A003 are executed in a
parallel way
    <process:parallel
    rdf:about=“http://semantics.crl.ibm.com/SinoPac#A004”/>
    //indicating activity A002 and A003 are executed in a
parallel way
    </process:Activity>
    //define activity A003
    <process:Activity
    rdf:about=“http://semantics.crl.ibm.com/SinoPac#A003”>
    <process:activityLabel
rdf:about=“http://semantics.crl.ibm.com/banking#Debit”/>
    //indicating activity A003 is Debit
    </process:Activity>
    //define activity A004
    <process:Activity
    rdf:about=“http://semantics.crl.ibm.com/SinoPac#A004”>
    <process:activityLabel
rdf:about=“http://semantics.crl.ibm.com/banking#Settlement”/>
    //indicating activity A004 is Settlement
    </process:Activity>
```

In FIG. 3, the method of the present invention may optionally choose to include validation for unified semantic model, after step S33 is completed. That is to say, after the unified semantic model is formed, some constraint rules can be defined as part of the ontology to validate the unified semantic model. For example, we can specify some rules like following:

to say that each “Activity” element in a business process model should represent for an “Operation” concept in the banking domain ontology;

to say that each “Object” element in a business process model should represent for a “Document” concept in the banking domain ontology

These constraints can also be transformed into the semantics model as follows:

```
    //define constraint activityLabel, indicating ‘Activity’
element should represent for an “Operation” concept in the banking
domain ontology <owl:ObjectProperty
rdf:about=“http://semantics.crl.ibm.com/constraints#activityLabel”>
    <rdfs:domain
rdf:about=“http://semantics.crl.ibm.com/process#Activity”/>
    <rdfs:range
rdf:about=“http://semantics.crl.ibm.com/banking#Operation”/>
    </owl:ObjectProperty>
    //define constraint objectLabel, indicating “Object”
element should represent for a ‘Document’ concept in the banking domain
ontology
    <owl:ObjectProperty
rdf:about=“http://semantics.crl.ibm.com/constraints#objectLabel”>
    <rdfs:domain
rdf:about=“http://semantics.crl.ibm.com/process#Object”/>
    <rdfs:range
rdf:about=“http://semantics.crl.ibm.com/banking#Document”/>
    </owl:ObjectProperty>
```

Then we can input the unified semantic model, containing model ontology, domain ontology, instances of model ontology (generated from normalized business operational models) and constraint ontology, to Inference Engine and check the consistency of the semantics model.

Here are two more complex rules that are provided by users.

Rule1: We should do “inquiry” before any kind of “transaction”

```
    //define activity A001
    <process:Activity
rdf:about=“http://semantics.crl.ibm.com/SinoPac#A001”>
    <process:activityLabel
rdf:about=“http://semantics.crl.ibm.com/banking#Inquiry”/>
    //define relationship precede
    <process:precede
rdf:about=“http://semantics.crl.ibm.com/process#Operation”/>
    </process:Activity>
    Rule2: We should do “settlement” after any kind of
“transaction”
    //define activity A004
    <process:Activity
rdf:about=“http://semantics.crl.ibm.com/SinoPac#A004”>
    <process:activityLabel
rdf:about=“http://semantics.crl.ibm.com/banking#Inquiry”/>
    <process:after
rdf:about=“http://semantics.crl.ibm.com/process#Operation”/>
    </process:Activity>
    //define relationship after
    <owl:ObjectProperty
rdf:about=“http://semantics.crl.ibm.com/process#after”>
    <owl:inverseOf
rdf:about=“http://semantics.crl.ibm.com/process#precede”/>
    </owl:ObjectProperty>
```

It is apparent that Rule 2 will make the semantics model generated in FIG. 7 inconsistent with Rule 2, since according to the instance of domain ontology for banking in FIG. 5, the ‘Loan’ in FIG. 7 belongs to ‘transaction’. That is to say, in FIG. 7, ‘transaction’ is parallel with ‘settlement’ rather than followed by ‘settlement’, thus it is inconsistent with Rule 2. Other application programs may receive inconsistent result of examination and adopt appropriate measures to alarm user, or automatically correct error so as to make semantics model be consistent.

The method according to the present invention may be encoded as program stored on the computer-readable storage medium, and can be realized by executing the program by a computer. Therefore, the present invention also includes the computer program product that is encoded according to the method of the present invention, as well as the computer readable medium storing the said computer program.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

That which is claimed is:

1. A method for integrating model and domain semantics in business models, comprising:
a business model inputting step for inputting a business model to be realized;
a domain semantics locating step for locating domain semantics of a modeling element of the business model within a domain ontology and outputting the corresponding domain model semantics;
a model semantics transforming step for transforming the modeling element of the business model into business model semantics that are represented by a model ontology; and
a unified semantic model forming step for combining the business model semantics and the domain model semantics and outputting a unified semantic model.

2. The method according to claim 1, wherein the model ontology is generated prior to the business model inputting step.

3. The method according to claim 1, wherein the domain ontology is prepared prior to the business model inputting step.

4. The method according to claim 3, wherein the domain ontology captures domain semantics that are used in the business model.

5. The method according to claim 4, wherein the domain semantics come from industry standards or domain experts.

6. The method according to claim 1, wherein the business model is normalized based on domain ontology prior to the business model inputting step.

7. The method according to claim 1, wherein the unified semantic model is validated after the unified semantic model generating step.

8. The method according to claim 7, wherein the formed unified semantic model is validated based on constraints embedded in the domain ontology, the model ontology, and user-provided rules or policies.

9. An apparatus for integrating model-level and domain-level semantics in business models, comprising:
a domain semantics locator configured to locate domain semantics of a modeling element of an input business model within a domain ontology and output corresponding domain model semantics;
a model semantics transformer configured to transform an input modeling element of the business model into business model semantics that are represented by a model ontology; and
a unified semantic model builder configured to combine the business model semantics and the domain model semantics and output the formed unified semantic model.

10. The apparatus according to claim 9, further comprising a model ontology generator used to generate model ontology prior to the input of the business model.

11. The apparatus according to claim 9, wherein the domain ontology is prepared prior to the input of the business model.

12. The apparatus according to claim 11, wherein the domain ontology captures domain semantics that are used in the business model.

13. The apparatus according to claim 12, wherein the domain semantics come from industry standards or domain experts.

14. The apparatus according to claim 9, further comprising a model normalizer used to normalize the business model based on domain ontology prior to the input of the business model.

15. The apparatus according to claim 9, further comprising a semantics model validator used to validate the unified semantic model after its generation by the unified semantic model builder.

16. The apparatus according to claim 15, wherein the semantics model validator validates the formed unified semantic model based on some constraints embedded in the domain and model ontology, and user-provided rules or policies.

17. A computer program product embodied in a tangible medium comprising:
computer readable program codes coupled to the tangible medium for integrating model and domain semantics in business models, the computer readable program codes comprising:
first computer readable program code configured to cause the program to input a business model to be realized;
second computer readable program code configured to cause the program to locate domain semantics of a modeling element of the business model within a domain ontology and output a corresponding domain model semantics;
third computer readable program code configured to cause the program to transform the modeling element of the business model into business model semantics that are represented by a model ontology; and
forth computer readable program code configured to cause the program to combine the business model semantics and the domain model semantics and output a unified semantic model.

18. The computer program product according to claim 17, wherein the domain ontology captures domain semantics that are used in the business model.

19. The computer program product according to claim 18, wherein the domain semantics come from industry standards or domain experts.

20. The computer program product according to claim 17, further comprising forth computer readable program code configured to cause the program to validate the formed unified semantic model based on constraints embedded in the domain ontology, the model ontology, and user-provided rules or policies.
